(19) United States
(12) Patent Application Publication
(10) Pub. No.: US 2018/0038110 A1
(43) Pub. Date: Feb. 8, 2018

(54) WATER GUTTER

(71) Applicant: Christopher Wilkinson, Brooklyn, NY (US)

(72) Inventor: Christopher Wilkinson, Brooklyn, NY (US)

(21) Appl. No.: 15/665,790

(22) Filed: Aug. 1, 2017

Related U.S. Application Data
(60) Provisional application No. 62/371,392, filed on Aug. 5, 2016.

(51) Int. Cl. E04D 13/076; H05B 1/00; E04D 13/064

(52) U.S. Cl. CPC E04D 13/076; E04D 13/064; H05B 1/00; E04D 13/00

(57) ABSTRACT

A gutter capable of evaporating water is provided for. The gutter features a pipe having a first opening, second opening, and a wall with an integrated heater and a number of vents located closed to the first opening, a water receiving opening and a water expelling opening where the water receiving opening and the water expelling opening are the first and second openings; a thermal storage system located within the wall and below the number of vents; and an evaporating steam vent placed on the wall and below the thermal storage system. The present invention can also have vacuum mechanism with an included shredding mechanism and compost dispensary for the shredded components.

### CLAIM OF PRIORITY

This application claims the priority of U.S. Ser. No. 62/371,392 filed on Aug. 5, 2016, the contents of which are fully incorporated herein by reference.

### FIELD OF THE EMBODIMENTS

The invention and its embodiments relate to a gutter that is capable of facilitating the removal of water via evaporation and by clearing any debris that are caught in the gutter.

### BACKGROUND OF THE EMBODIMENTS

Gutters are used on most structures built today. The shape of a building's roof can help guide the flow of water, more often than not gutters are also used to aid in this task. While gutters are used throughout the globe, they experience problems such as leaking, overflowing, sagging, clogging all of which can result runoff being pooled outside the structure.

There are a number of ways in which people have tried to improve gutters over the years. To address the problem of debris, many gutters are equipped with a screen that stop debris from falling in the gutter. While these are helpful initially, they are prone to breaking due, and do not provide a lasting solution. Many gutters are made to be larger in order to accommodate large amounts of water, but the wider a gutter gets, the greater likelihood of the aforementioned problems due to lack of structural integrity among other issues.

As such, there is a need for a system that can remove large amounts of water form an area, clean any debris autonomously, and facilitate the flow of water via vacuum.

Review of related technology:

U.S. Pat. No. 3,971,098 pertains to a device for cleaning gutters without having to use stepladders or other elevating means. This invention is in the form of a novel nozzle used in conjunction with wet/dry vacuum systems.

U.S. Pat. No. 4,807,406 pertains to a self-cleaning gutter system formed from two, horizontal, longitudinal halves interlocked along the gutter bottom longitudinal axis. The back half, immediately adjacent to the house or building is fixedly attached thereto. At either end of the gutter a piece transverse to the gutter's longitudinal axis protrudes from the ends of the gutter half fixedly attached to the house or building. A rod is positioned within the gutter along the gutter's longitudinal axis protruding at either end of the gutter through the transverse piece. The front half of the gutter has arms extending therefrom which are journaled to the rod. A gearing system attached to said protruding end engages an actuator shaft which extends vertically to ground level. The ground end of the vertical shaft is journaled to a simple geared handle. The operation of the handle will cause the front half of the gutter to open 180°, thereby dumping debris, ice and snow to the ground.

U.S. Pat. No. 5,195,209 pertains to a gutter cleaning system which includes a canister type vacuum cleaner with tubular wand sections with a nozzle adapted to be inserted into a gutter to remove debris therein. The nozzle carries an optical viewing system such as a fiber optic device or a television camera enabling the operator to observe the cleaning operation as it is performed.

U.S. Pat. No. 6,185,782 pertains to a rain-gutter cleaning system has an agitator head that is mounted to the top end of a long suction tube and pole and supported aloft by them. A vacuum pump on the ground is connected to bring rain-gutter debris down the suction tube and into a collection bag. The agitator head includes rotating paddles that tear and break up tangles and clogs encountered in a rain gutter and has a rotating auger screw inside that helps direct the loosened debris down the throat of the suction tube. A camera mounted atop the agitator head allows an operator on the ground below to see the inside of the rain gutter on a small monitor screen.

U.S. Pat. No. 6,314,685 pertains to a gutter enhancing device having a flexible member for being applied to and covering the exterior configuration of an existing gutter trough. The device also has a flexible screen portion for covering the top portion or opening of the gutter trough.

U.S. Patent Publication No.: 2004/0020516 pertains to a method for removing debris from a roof gutter includes the steps of providing a vacuum conduit having a first end located in proximity to the debris in the gutter and a second end connected to a vacuum tank, having a vacuum producing means, the first end of the vacuum conduit having water and/or air dispensing means to dislodge or make vacuum able the debris located within the gutter. The debris is vacuumed into the vacuum tank by means of the vacuum conduit. Mechanical means may also be utilized in proximity of the first end of the vacuum conduit to break up debris. A monitoring means may be utilized in proximity to the first end of the vacuum conduit to monitor vacuuming progress and/or control vacuum and/or debris dislodging means.

U.S. Patent Publication No.: 2006/0037253 pertains to a gutter protection system includes a foam insert which is installed in the hanging gutters of commercial and residential buildings. The gutter insert allows rain water to drain into the gutters, yet it prevents debris from entering the channel and clogging the gutter pathway. The foam insert includes antimicrobial and/or UV stabilizer additives to improve the useful life of the foam insert.

Foreign Patent Document No.: DE202006016998 pertains to a cleaner which has a suction pipe and a suction funnel with a cross sectional arrangement. An inlet is adjusted corresponding to a gap between roofing tiles and a gutter edge. A leaf sucker is used with a manifold for pipe connection. The funnel is arranged in a rotatable manner with a double-joint. A camera is installed in the cleaning area to display the performance on a screen for controller the cleaning process. The funnel is transparent to control the suction function.

Foreign Patent Document No.: DE202009003098 pertains to a thermal solar heating system, characterized in that the solar cycle below the collector in the High gutter is interrupted and a gutter heater is installed as a bypass in the form of a pipe loop in the gutter

Foreign Patent Document No.: CN203022240U pertains to a novel greenhouse energy-saving and heat preservation gutter which is composed of a hot galvanizing steel water groove, a gutter side aluminum pressing strip, a butyl seal adhesive tape, a greenhouse roof cover material, a rubber and plastic sponge plate, a sponge plate side receiving aluminum bar, a roof truss connecting piece, a double-end positioning bolt and nut, a stand column support piece and a W-shaped water collecting groove. After the rubber and plastic sponge plate is pasted with the lower edge of the hot galvanizing steel water groove, the sponge plate side receiving aluminum bar is fixed on two sides to form a whole. The butyl seal adhesive tape is pasted on the upper edge of the hot galvanizing steel water groove, the roof cover material is paved on the butyl seal adhesive tape on the upper edge of the hot galvanizing steel water groove along a roof, the gutter side aluminum pressing strip is fixed on the hot galvanizing steel water groove through tail pins, the hot galvanizing steel water groove is connected with the stand column support piece through the double-end positioning bolt and nut, the roof truss connecting piece is connected with the hot galvanizing steel water groove through the double-end positioning bolt and nut, and the W-shaped water collecting groove is connected with the greenhouse stand column support piece in a riveting mode. The novel greenhouse energy-saving and heat preservation gutter has the main advantages that a traditional hot galvanizing steel gutter is replaced, the purposes of preserving heat, insulating the heat, saving energy and reducing consumption are achieved, production of condensate water can be effectively reduced, greenhouse operation cost is reduced, the roof condensate water is collected through the W-shaped water collecting groove, effects on crop quality from dripping water are prevented, and production effects of a greenhouse are improved.

Various devices are known in the art. However, their structure and means of operation are substantially different from the present invention. Such devices fail to provide a device that can clear a clogged gutter and facilitate the removal of water by evaporating it. At least one embodiment of this invention is presented in the drawings below, and will be described in more detail herein.

### SUMMARY OF THE EMBODIMENTS

The present invention provides for a gutter capable of evaporating water, comprising: a pipe having a first opening, second opening, and a wall, wherein the wall has an integrated heater and a plurality of vents disposed proximate to the first opening; a water receiving opening and a water expelling opening, wherein the water receiving opening and the water expelling opening are the first and second openings; a thermal storage system disposed within the wall and below the plurality of vents; an evaporating steam vent disposed on the wall and below the thermal storage system. In some embodiments, the present invention features a vacuum mechanism and a vacuum port, comprising a tube having a vacuum wall, a first end connected to a vacuum source and a second end connected to the vacuum port, and a compost outlet; a shredding mechanism, disposed within the tube; a plurality of closable vents disposed on the vacuum wall; and a compost dispensary connected to the compost outlet. Sometimes, an outer coating is disposed on the wall of the pipe. Preferably, the outer coating is constructed out of stainless steel or substantially out of nickel. In many embodiments, the vacuum source is a vacuum pump and in other the outlet port is below the first opening and the second opening.

Other embodiments of the present invention exist where a funnel attached to the first opening and others still exist where the heating element is configured to generate enough heat to evaporate water. Preferably, the compost dispensary is removably attached to the gutter. In many embodiments the plurality of closeable vents having an open and closed position and can be toggled between the two positions. In a highly preferred embodiment the shredding mechanism is configured to shred wood.

The present invention meets and exceeds the following objectives:

It is an object of the present invention to provide a system that is capable of quickly evaporating large amounts of water.

It is an object of the present invention to provide a means for automatically cleaning a gutter.

It is an object of the present invention to provide a means for composting debris from trees.

### BRIEF DESCRIPTION OF THE DRAWINGS

FIG. 1 shows a schematic view of an embodiment of the present invention equipped with the vacuum mechanism.

FIG. 2 shows a schematic view of an embodiment of the present invention.

FIG. 3 shows a schematic view of an embodiment of the vacuum mechanism of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof.

Therefore, it is intended that the disclosure not be limited to the particular embodiments disclosed.

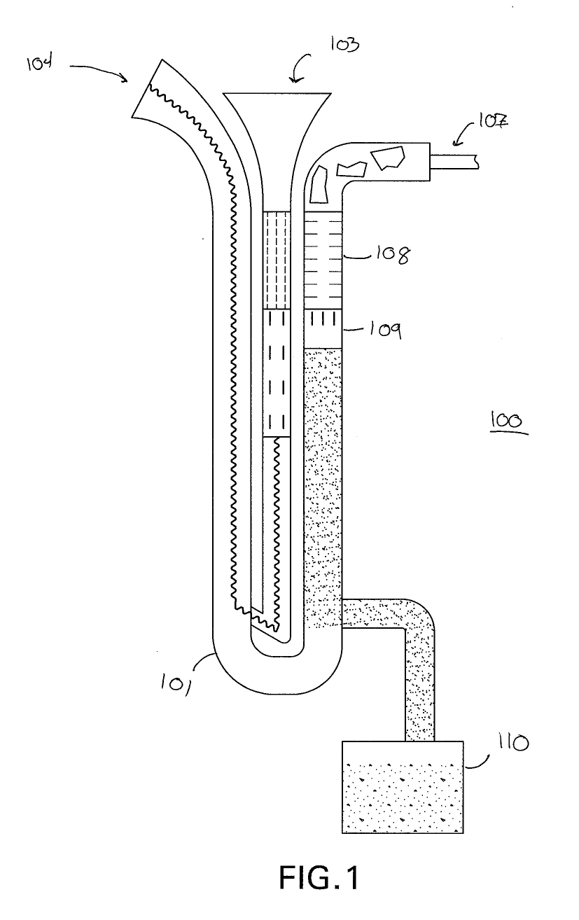

Referring to FIG. 1, a schematic view of an embodiment of the present invention equipped with the vacuum mechanism is shown. Here, gutter 100 features pipe 101, plurality of vents 102, water receiving opening 103, water expelling opening 104, thermal storage system 105, evaporating steam vent 106, vacuum mechanism 107, shredding mechanism 108, plurality of closable vents 109, and compost dispensary 110. Pipe 101 has a first opening, a second opening, and a wall. Preferably the wall is disposed with plurality of vents 102. More preferably, the plurality of vents are proximate to the first opening, which is configured to receive water. In many embodiments the second opening is configured to be a water-expelling opening.

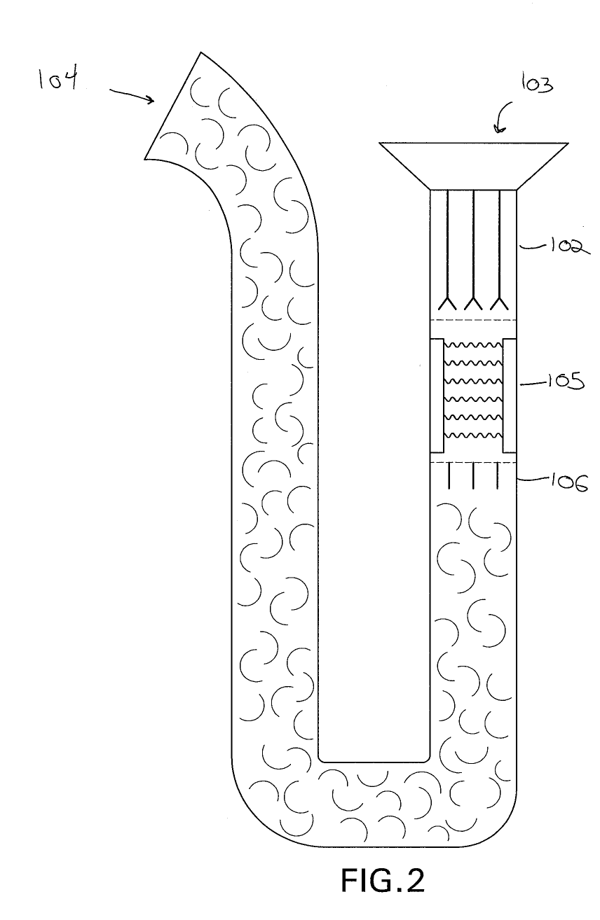

FIG. 2 shows a schematic view of an embodiment of the present invention. Here, portions of pipe 101 that are proximate to this second opening will preferably be thermal heating walls. These wall shall be capable of evaporating water at an increased rate when compared with the ambient environment. Using thermal energy to heat up the water to the point of evaporation, this portion of pipe 101 well facilitate the flow of water, particularly when large volumes of water are flowing through pipe 101. Preferably, there is a second portion of pipe 101 that is heated, and that area is located below plurality of vents 102. Water will be sucked through the pipe via a vacuum tunnel powered by a vacuum source. Preferably, this source is a vacuum pump, but other methods of creating a vacuum are acceptable for use with the present invention.

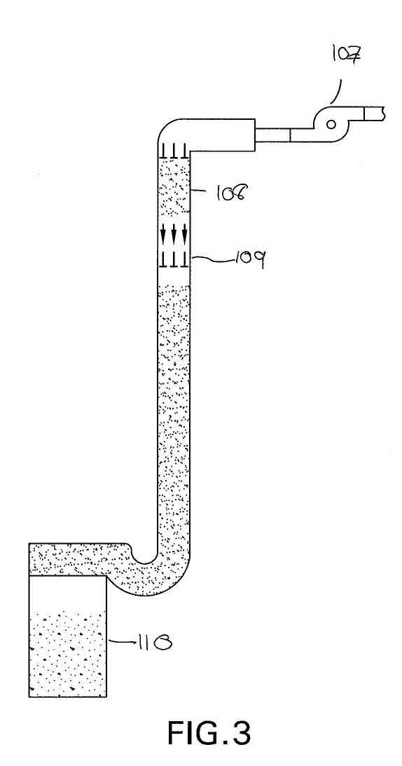

Referring to FIG. 3, a schematic view of an embodiment of the vacuum mechanism of the present invention is shown. Here, the vacuum and composting section of an embodiment of the present invention are shown. Vacuum mechanism 107, shredding mechanism 108, plurality of closable vents 109, and compost dispensary 110 are shown. Here, the present invention is used to draw water through this part of pipe 101 and is capable of cleaning any debris that enter the pipe 101. Preferably, shredding mechanism 108 is disposed within pipe 101. Vacuum mechanism 107 will draw and solid debris into this section of pipe 101 which will then by ground up by shredding mechanism 108. The smaller bits will fall down pipe 101 into the compost dispensary 110. The compost dispensary 110 is preferably removably attached to the present invention.

In a preferred embodiment, the present invention also features a computerized self-diagnostic system that can be controlled from an internet-enabled mobile device. Preferably, the present invention will feature at least one camera which can feed an image to the mobile device. The present invention also comprises software for the mobile device to allow the gutter to troubleshoot and repair mechanical problems. Preferably, the software application will include step-by-step instructions for troubleshooting.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A gutter capable of evaporating water, comprising:
a pipe having a first opening, second opening, and a wall,
wherein the wall has an integrated heater and a plurality of vents disposed proximate to the first opening;
a water receiving opening and a water expelling opening,
wherein the water receiving opening and the water expelling opening are the first and second openings;
a thermal storage system disposed within the wall and below the plurality of vents;
an evaporating steam vent disposed on the wall and below the thermal storage system.

2. The gutter of claim 1, further comprising a vacuum mechanism.

3. The gutter of claim 2, the pipe further comprising a vacuum port,
the vacuum mechanism comprising:
a tube having a vacuum wall, a first end connected to a vacuum source and a second end connected to the vacuum port, and a compost outlet;
a shredding mechanism, disposed within the tube;
a plurality of closable vents disposed on the vacuum wall; and
a compost dispensary connected to the compost outlet.

4. The gutter of claim 1, further comprising an outer coating disposed on the wall.

5. The gutter of claim 2, wherein the outer coating is constructed out of stainless steel.

6. The gutter of claim 1, wherein the heating mechanism is constructed substantially out of nickel.

7. The gutter of claim 3, wherein the vacuum source is a vacuum pump.

8. The gutter of claim 3, wherein the outlet port is below the first opening and the second opening.

9. The gutter of claim 1, further comprising a funnel attached to the first opening.

10. The gutter of claim 1, wherein the heating element is configured to generate enough heat to evaporate water.

11. The gutter of claim 3, wherein the compost dispensary is removably attached to the gutter.

12. The gutter of claim 3, wherein the plurality of closeable vents having an open and closed position and can be toggled between the two positions.

13. The gutter of claim 3, wherein the shredding mechanism is configured to shred wood.
